(19) United States
(12) Patent Application Publication
(10) Pub. No.: US 2006/0230540 A1
(43) Pub. Date: Oct. 19, 2006

(54) Patient hand support aid for bed

(76) Inventor: Mary Whelan, Victoria (AU)

Correspondence Address: EDWIN D. SCHINDLER, FIVE HIRSCH AVENUE, P.O. BOX 966, CORAM, NY, 11727-0966, US

(21) Appl. No.: 10/557,500

(22) PCT Filed: May 21, 2004
(86) PCT No.: PCT/AU04/00684

§ 371 Date: Nov. 17, 2005

(30) Foreign Application Priority Data
May 22, 2003 (AU) 2003902514

(51) Int. Cl. A61G 7/053

(52) U.S. Cl. 5/662

(57) ABSTRACT

A support aid for assisting an infirmed person to move into, and out of, a bed, includes a first support member and a device for attaching the first support member to a bed frame. A second support member is pivotally connected to the first support member with the second support member able to be moved from a substantially horizontal position along the bed frame to a substantially vertical position, with a clamp or other fixing device able to maintain the second support member in the substantially vertical position.

### TECHNICAL AREA

This invention relates to the area of the provision of aids and appliances for use in hospitals, nursing homes and homes and in particular to the provision of aids which assist a patient or any person who is infirm, or who otherwise has difficulty moving in or out of a bed, to self mobilise or support.

### BACKGROUND TO THE INVENTION

It has long been an occupational hazard for nursing staff and carers dealing with people of limited mobility to lift and generally handle such people. Additionally many nursing staff are unaware of what their patient's capacity for movement is and may make some people overly dependent on them for fear of dropping the patient or some other accident occurring. This would of course impede any rehabilitation which could be achieved by a patient.

Awkward procedures such as lifting patients contribute significantly to occupational hazards such as the development of back pain in nurses while the patient meanwhile may feel quite nervous and unstable while the procedure concerned is being carried out and lose confidence in their own ability to cope with self mobilisation.

Various lifting devices for patients, particularly in hospitals and nursing homes, do exist however these tend to be cumbersome and still require manipulation of a patient into and out of such devices.

Many patients or elderly people are not totally incapacitated and if provided with appropriate structures should be able to either support themselves or assist in their own movement and support.

It is known for wall mounted bars to be provided in showers and toilets and such like to provide support for the users. Devices to assist a person in moving into and out of bed are not readily available and where provided act as fixed obstructions. One such product is a bed pole or bed stick which sits under a mattress and is held in place by the weight of a person in a bed. Its primary purpose is to provide mobility around a bed but as it is not fixed to anything solid, such as a bed frame, a person cannot use it for support reliably when getting into or out of bed.

### OUTLINE OF THE INVENTION

It is an object of this invention to provide a stable support means, preferably used in association with a bed, which permits a user to more easily support their weight than other devices and thereby provide a person with the security of being self supporting and minimising the requirement for nursing staff to support the person.

The invention is a support aid for use by patients or others which aid includes attachment means to attach it to a bed frame which attachment means acts as a base for a first support member pivotally connected to a second support member such that this second support member can move from a generally horizontal position along a bed frame to a generally vertical position when means for fixing it in the vertical position is applied.

It is preferred that the attachment means to the bed frame be a clamp device and that when in situ on the frame the first support member extends vertically from it.

It is also preferred that the first and second support members have a similar diameter and that the means for fixing the second support member in the vertical be a sleeve adapted to slide over both support members encompassing the pivotal connection. The arrangement is such that the sleeve means can pass over the pivotal connection and hold the support aid upright or alternatively, if moved away from it, permit the second support member to lie generally along one side or another of the bedframe.

It is further preferred that the second support member be able to pivot through an angle of 180 degrees relative to the first support member.

It may be preferred that the second member be provided with telescopic means to adjust its length however it is preferred that a terminal end thereof be provided with handle means.

It is preferred that this handle means be a hand grip however a handle of any shape or type may be provided.

In order that the invention may be more readily understood we will describe by way of non limiting example a specific embodiment of the invention with reference to the accompanying drawings.

### BRIEF DESCRIPTION OF THE DRAWING FIGURES

FIG. 1 is a perspective view of the support aid of the invention in its upright orientation;

FIG. 2 is a perspective view of the support aid of the invention in its generally horizontal orientation;

FIG. 3 is an exploded diagram of the component parts of the invention;

### DESCRIPTION OF A PREFERRED EMBODIMENT OF THE INVENTION

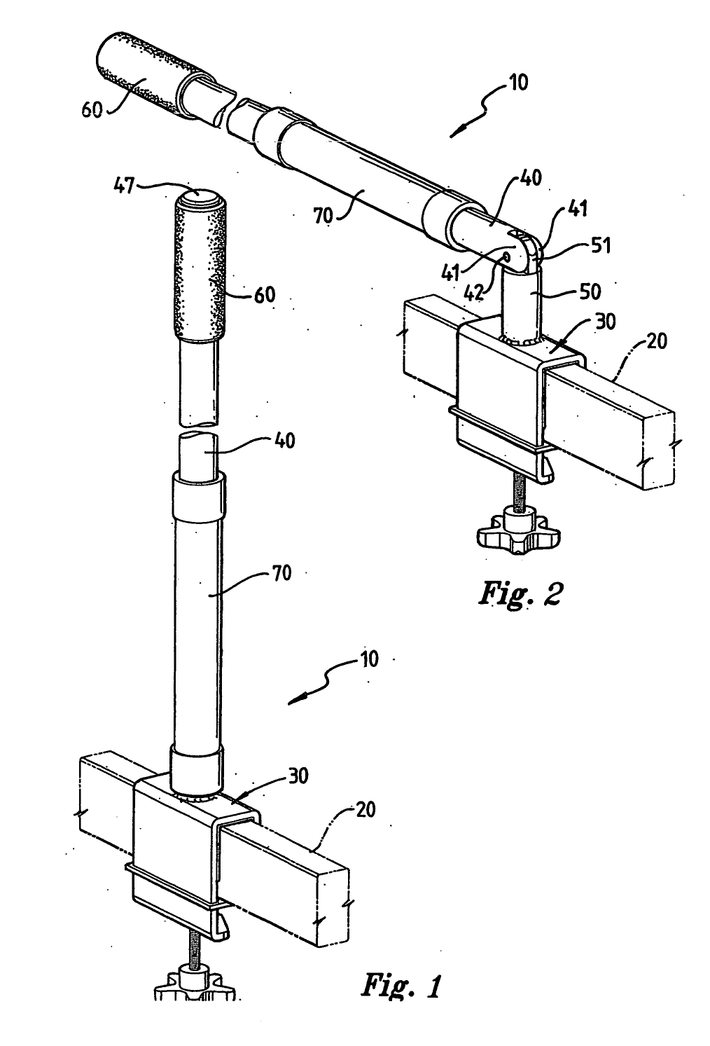

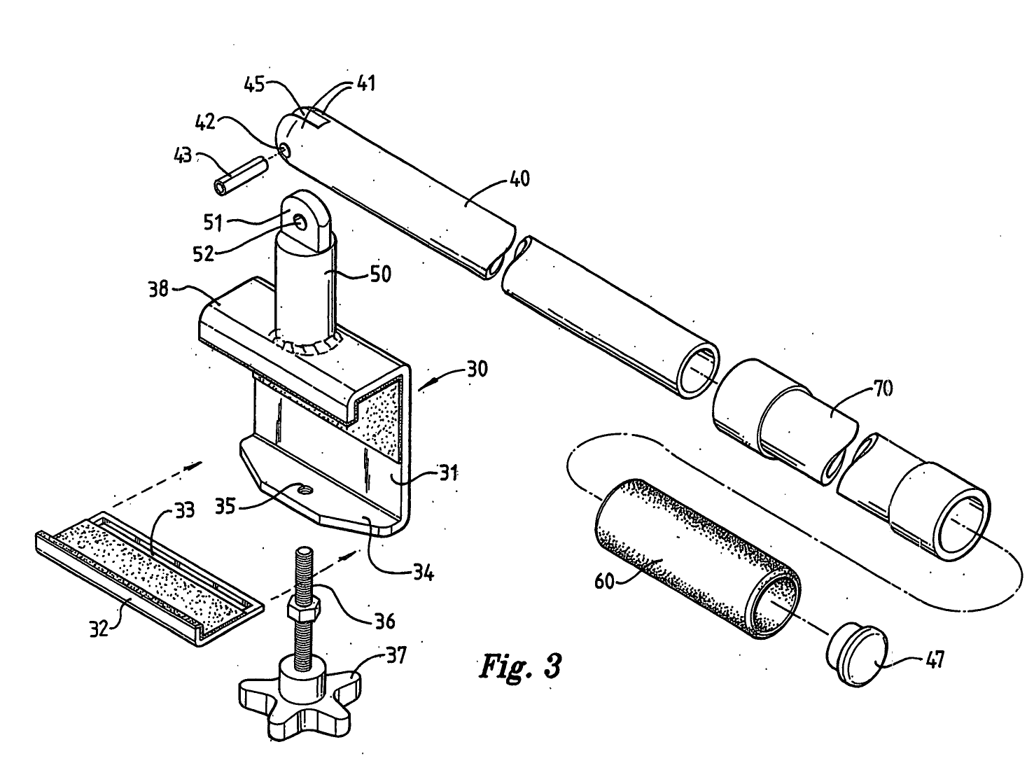

In the embodiment of the invention described here and shown in FIGS. 1 to 3 a support aid 10 is provided which attaches to a bed frame 20 by clamp means 30.

The clamp means 30 has two basic components the first having an upper face 38 adapted to pass over a bed frame and having vertical face 31 and lower face 34. This component is adapted to engage with the other clamp component 32 such that component 32 can slide along face 31 which passes through aperture 33.

As shown in FIGS. 1 and 2 component 32 can then be tightened to the lower side of bed frame 20 by means of the pressure applied to the lower face of component 32 by a threaded bolt member 36 with knob 37 which can be screwed through aperture 35 in the base 34 of the first clamp component thereby affixing the support aid securely to a bed frame in an adjustable fashion.

The actual support componentry of the support aid 10 includes a short tubular component 50 extending from face 38 of clamp component 30. The terminal end of this component is provided with a boss 51 with aperture 52 through it This boss can enter an aperture 45 in a longer tubular member 40 between flanges 41 and be pivotally connected thereto by means of pin 43 passing through apertures 42 and 52. By this means tubular member 40 can rotate through 180 degrees around pin 43 at this pivotal connection point.

The support aid is provided with a sleeve 70 which can slide along tubular component 40 and over the pivotal connection point as shown in FIG. 1 to hold component 40 in a vertical orientation. The tubular component 40 is provided with handle grip means 60 at its terminal end and the tubular member is closed with cap 47.

The precise type of handle provided is not restricted in the invention and any chosen shape or type could be used. It is however desirable that some grip means be provided to assist a patient in holding the support aid. The type of clamp means used is also not restricted in the invention nor is the means of holding the support aid in its vertical position or the means of interconnection between the vertical components. It is however essential that the support aid have a vertical component which can assume both a vertical and generally horizontal orientation.

The embodiment of the invention described here is extremely simple to install and to use. It has the advantage that when not required the support aid can lie along the side of a patients bed in an unobtrusive manner. When a patient requires support to get either into or out of bed or requires support when out of bed it is a simple matter to raise the longer support member such that the sleeve slides down and fixes it temporarily in an upright position.

It is envisaged that an embodiment of the invention may include telescopic support components or and that any means customarily used may be applied for this purpose.

The invention however is unique in that it provides a support device which can be attached to a bed frame wherever it is required but which may be raised and lowered as required.

Whilst I have described herein a specific embodiment of the invention it is envisaged that other embodiments of the invention will exhibit any number of and any combination of the features previously described and it is to be understood that variations and modifications in this can be made without departing from the spirit and scope thereof.

1-9. (canceled)

10. A support aid for assisting an infirmed person to move into, and out of, a bed, comprising:
a first support member;
means for attaching said first support member to a bed frame;
a second support member pivotally connected to said first support member, said second support member being movable from a substantially horizontal position along the bed frame to a substantially vertical position; and,
means for fixing said second support member in said substantially vertical position.

11. The support aid for assisting an infirmed person to move into, and out of, a bed according to claim 10, wherein said means for attaching said first support member to a bed frame is a clamping device.

12. The support aid for assisting an infirmed person to move into, and out of, a bed according to claim 10, wherein said first support member and said second support member have substantially equal diameters with said means for fixing said second support member in said substantially vertical position being a coaxial sleeve device slidable over both said first support member and said second support member and encompassing the pivotal connection between said first support member and said second support member.

13. The support aid for assisting an infirmed person to move into, and out of, a bed according to claim 12, wherein said coaxial sleeve device is passable over said pivotal connection and holds said support aid in an upright position.

14. The support aid for assisting an infirmed person to move into, and out of, a bed according to claim 12, wherein said coaxial sleeve device is passable over said pivotal connection and, when said coaxial sleeve device is moved away from said pivotal connection, said coaxial sleeve device permits said second support member to lie substantially alongside the bed frame.

15. The support aid for assisting an infirmed person to move into, and out of, a bed according to claim 10, wherein said second support member is pivotable through an angle of 180° relative to said first support member.

16. The support aid for assisting an infirmed person to move into, and out of, a bed according to claim 10, further comprising a handle located at a terminal end of said second support member.

17. The support aid for assisting an infirmed person to move into, and out of, a bed according to claim 16, wherein said handle includes a hand grip.

18. The support aid for assisting an infirmed person to move into, and out of, a bed according to claim 10, wherein said second support member includes means for extending its length.
